(19) United States
(12) Patent Application Publication
(10) Pub. No.: US 2026/0292942 A1
(43) Pub. Date: Sep. 24, 2026

(54) INDUCTIVE HEATING DEVICE FOR CONSTANT ENERGY SUPPLY

(71) Applicant: Philip Morris Products S.A., Neuchatel (CH)

(72) Inventor: Enrico STURA, Palézieux-Village (CH)

(73) Assignee: Philip Morris Products S.A., Neuchatel (CH)

(21) Appl. No.: 19/477,554

(22) PCT Filed: Apr. 26, 2024
(86) PCT No.: PCT/EP2024/061658

§ 371 Date: Oct. 22, 2025

(30) Foreign Application Priority Data
Apr. 27, 2023 (EP) 23170239

(51) Int. Cl. H05B 6/06; A24F 40/465; A24F 40/51; A24F 40/57; H05B 6/10

(52) U.S. Cl. CPC H05B 6/06; A24F 40/465; A24F 40/51; A24F 40/57; H05B 6/105

(57) ABSTRACT

An inductive heating arrangement to heat an aerosol-forming substrate is provided, including: an LC load network to generate an alternating magnetic field to inductively heat the substrate; a DC power source; and a DC/AC inverter to connect to the power source and LC load network, the inverter including: a voltage sensor to measure a DC input voltage from the power source, a transistor, a transistor driver circuit including a tunable oscillator to output a switching signal to the transistor, and a controller to receive a voltage signal from the voltage sensor indicative of the input voltage, determine a switching frequency based on the voltage signal, in response to the received signal, control the oscillator to tune a switching frequency of the signal to the determined switching frequency, and determine the switching frequency based on a conversion table, the conversion table defining a relationship between the signal and the switching frequency.

The present disclosure relates to inductive heating arrangements for heating an aerosol-forming substrate.

An inductive heating device may comprise an inductive heating arrangement for heating of an aerosol-forming substrate. The inductive heating arrangement may include an induction source for inductively heating a susceptor arrangement, which is in thermal proximity or direct physical contact with the aerosol-forming substrate to be heated. The induction source may be configured to generate an alternating magnetic field, which induces at least one of heat generating eddy currents or hysteresis losses in the susceptor arrangement.

Inductive heating devices may be portable or handheld devices. One or more batteries may power these inductive heating devices. A limiting factor of these inductive heating devices may be these batteries. Once a battery is discharged due to usage of the inductive heating device, it has to be recharged. How often or how long an inductive heating device can be used depends on size and the energy density of the battery.

However, a problem with the battery is that the size of the battery is limited due to the size of the inductive heating device. Another problem is that not every type of battery can be chosen as a power source for the inductive heating device. For example, some types of batteries may have a high energy density compared to other types of batteries. However, the types of batteries with the higher energy density may have characteristics that can lead to inconsistent heating of an aerosol-forming substrate. For example, a voltage of a battery may vary based on a depth of discharge of the battery. This could lead to inconsistent heating of an aerosol-forming substrate.

An option to overcome this problem could be to implement a DC/DC converter in the inductive heating device to modulate the varying voltage of the battery. However, the conversion may be inefficient and could lead to an energy loss, which may result in an undesired increase in the temperature of the inductive heating device.

Accordingly, it would be desirable to facilitate an improved and compact inductive heating device that can be operated with high energy density batteries in an efficient and safe manner.

According to an aspect of the present invention, there is provided an inductive heating arrangement for heating an aerosol-forming substrate. The inductive heating arrangement comprises: an LC load network configured to generate an alternating magnetic field during operation of the inductive heating arrangement for inductively heating an aerosol-forming substrate; and a DC/AC inverter configured to connect to a DC power source having a DC supply voltage and to the LC load network, wherein the DC/AC inverter comprises: a voltage sensor configured to measure a DC input voltage drawn from the DC power source; a transistor; a transistor driver circuit for the transistor, wherein the transistor driver circuit comprises a tunable oscillator configured to output a switching signal to the transistor; and a controller configured to receive a voltage signal from the voltage sensor indicative of the DC input voltage. The controller is configured to determine a switching frequency based on the voltage signal, and the controller is configured to, in response to the received voltage signal, control the tunable oscillator to tune a switching frequency of the switching signal to the determined switching frequency.

By providing an inductive heating arrangement comprising a controller configured to control a tunable oscillator to tune a switching frequency of the switching signal to a determined switching frequency, a power source with varying voltage over time or different power sources with different DC supply voltages can be used for powering the inductive heating arrangement, since a current or power drawn from the power source can be adjusted to the requirements or needs of the inductive heating arrangement. This significantly increases the flexibility of the choice of battery for the inductive heating arrangement. The inductive heating arrangement may be comprised in an aerosol-generating device.

According to aspects, the DC/AC inverter is configured to operate with different types of DC power sources having different DC supply voltages. The different types of DC power sources may have different ranges of DC supply voltage during a discharging process.

This allows implementing the same DC/AC inverter in different inductive heating devices or different aerosol-generating devices operating with different DC power sources, which saves the cost of manufacturing these devices.

According to aspects, the voltage sensor is configured to measure the DC input voltage during operation of the inductive heating arrangement. The voltage sensor may be configured to measure the DC input voltage in less than 1 second after a start of a heating process. By determining the DC input voltage during operation of the inductive heating arrangement, the DC input voltage can be determined in a precise manner. Further, by measuring the DC input voltage in less than 1 second after a start of the heating process, the process of tuning a switching frequency of the switching signal to the determined switching frequency does not significantly interfere with a user experience of the user using the inductive heating arrangement.

The voltage sensor may be configured to measure the DC input voltage in a loaded circuit. The term “loaded circuit” means that the aerosol-generating substrate is being inserted into or engaged with the inductive heating arrangement or a device comprising the inductive heating arrangement. The DC input voltage may also be estimated from an unloaded circuit based on a correlation between DC input voltages of the loaded and the unloaded circuit. A value indicative of DC supply voltage of the power source obtained from the unloaded circuit may be used to estimate the DC input voltage at load. Thus, the voltage sensor may be configured to measure the DC input voltage in an unloaded circuit. This allows tuning the switching frequency of the switching signal to the determined switching frequency even faster compared to the measurement in the loaded circuit.

According to aspects, the controller is configured to determine a switching frequency based on the voltage signal by selecting a predetermined switching frequency corresponding to the voltage signal.

According to aspects, the controller is configured to determine the switching frequency based on a conversion table. The controller may be configured to control the tunable oscillator to tune the switching frequency based on only the voltage signal. The conversion table may define a relationship between the DC input voltage or the voltage signal and the switching frequency. The conversion table may be incorporated in a firmware of the controller. The switching frequency may be tunable in a range between 5.4 MHz and 8 MHz. The switching frequency may be tunable in a range between 6.0 MHz and 7.5 MHz. The switching frequency may be tunable in a range between 6.4 MHz and 7.2 MHz. The switching frequency may be tunable in a range between 6.5 MHz to 7.0 MHz. By using a conversion table, the switching frequency can be tuned to the determined switching frequency in an effective and fast manner.

According to aspects, the inductive heating arrangement comprises the DC power source. The DC power source may comprise at least one nickel cobalt manganese (NCM) battery. NCM batteries may have a higher energy density and a higher initial voltage compared to lithium iron phosphate (LFP) batteries. NCM batteries may allow a user to use the inductive heating arrangement or a device comprising the inductive heating arrangement more often or longer compared to LFP batteries. Further, the inductive heating arrangement avoids the problems associated with NCM batteries of having a varying voltage depending on the discharging process. The varying voltage may also vary the power drawn from the battery, which could lead to an inconsistent of user experience of the user using the inductive heating arrangement or a device comprising the inductive heating arrangement.

The DC supply voltage of the DC power source may vary in dependence on a state of charge of the DC power source. The state of charge of the DC power source may be described as the current capacity of the battery, or the energy stored in the battery. Normally, the state of charge of the battery is expressed using the units “ampere hours”. The supply voltage of the DC power source may decrease as the state of charge of the DC power source decreases, particularly the supply voltage of the DC power source may decrease by 0.5V or more, or 1V or more, from a fully charged state to a totally or partially discharged state. The DC power source may be a user-replaceable DC power source. The DC power source may be removed from the inductive heating arrangement (or the aerosol-generating device comprising the inductive heating arrangement) by a user, and replaced with a different DC power source.

According to an aspect, an inductive heating system comprises: a first inductive heating device comprising: a first DC power source for providing a first DC supply voltage; and a first heater module comprising: a first DC/AC inverter having a variable switching frequency; and a first inductor for providing inductive heating, wherein the first DC/AC inverter is configured to provide power to the first inductor in accordance with a first switching frequency determined based on the first DC supply voltage; and a second inductive heating device comprising: a second DC power source for providing a second DC supply voltage that is different to the first DC supply voltage; and a second heater module comprising: a second DC/AC inverter having a variable switching frequency; and a second inductor for providing inductive heating, wherein the second DC/AC inverter is configured to provide power to the second inductor in accordance with a second switching frequency determined based on the second DC supply voltage, wherein the power provided by the first DC/AC inverter corresponds to the power provided by the second DC/AC inverter.

According to an aspect, a method performed for operating an inductive heating arrangement comprises: instructing a voltage sensor to measure a DC input voltage drawn from a DC power source; receiving a voltage signal from the voltage sensor, wherein the voltage signal is indicative of the DC input voltage; determine a switching frequency based on the voltage signal; and instruct a tunable oscillator, generating a switching signal for a transistor of the inductive heating arrangement to tune a switching frequency of the switching signal to the determined switching frequency. The voltage sensor may be instructed to measure the DC input voltage in less than 1 second after a start of a heating process. The voltage sensor may be instructed to measure the DC input voltage when the inductive heating arrangement is not engaged with an aerosol-generating article. The switching frequency may be determined based on a conversion table. The conversion table may define a relationship between the voltage signal or the DC input voltage and the switching frequency. By instructing the tunable oscillator, generating a switching signal for the transistor of the inductive heating arrangement to tune a switching frequency of the switching signal to the determined switching frequency, the power or current drawn from the DC power source can be adjusted or modified to be in a predetermined range.

According to an aspect, a computer-readable medium comprises instructions which, when executed by a controller, cause the controller to perform the method according to aspects as disclosed herein after.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomizer, such as an electric heater, to heat the aerosol-forming substrate to form an aerosol.

As used herein, the term “aerosol-forming substrate disposed in and/or engaged with the aerosol-generating device” refers to the combination of an aerosol-generating device with an aerosol-forming substrate. When the aerosol-forming substrate forms part of an aerosol-generating article, the aerosol-forming substrate disposed in and/or engaged with the aerosol-generating device refers to the combination of the aerosol-generating device with the aerosol-generating article. The aerosol-forming substrate and the aerosol-generating device may cooperate to generate an aerosol.

As used herein, the term “aerosol-forming substrate” refers to a substrate capable of releasing volatile compounds that can form an aerosol. The volatile compounds may be released by heating the aerosol-forming substrate. As an alternative to heating, in some cases, volatile compounds may be released by a chemical reaction or by a mechanical stimulus, such as ultrasound. The aerosol-forming substrate may be solid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. The aerosol may comprise nicotine. An aerosol-generating article may be disposable. An aerosol-generating article comprising an aerosol-forming substrate comprising tobacco may be referred to herein as a tobacco stick.

An aerosol-forming substrate may comprise nicotine. An aerosol-forming substrate may comprise tobacco, for example a tobacco-containing material containing volatile tobacco flavor compounds, which are released from the aerosol-forming substrate upon heating. In preferred embodiments an aerosol-forming substrate may comprise homogenized tobacco material, for example cast leaf tobacco. The aerosol-forming substrate may comprise both solid and liquid components. The aerosol-forming substrate may comprise a tobacco-containing material containing volatile tobacco flavor compounds, which are released from the substrate upon heating. The aerosol-forming substrate may comprise a non-tobacco material. The aerosol-forming substrate may further comprise an aerosol former. Examples of suitable aerosol formers are glycerin and propylene glycol.

As used herein, the term “inductive heating arrangement” refers to an arrangement in at least one of an “inductive heating device” and an “aerosol-generating device”.

The invention is defined in the claims. However, below there is provided a non-exhaustive list of non-limiting examples. Any one or more of the features of these examples may be combined with any one or more features of another example, embodiment, or aspect described herein.

Example Ex1. An inductive heating arrangement for heating an aerosol-forming substrate, the inductive heating arrangement comprising:
an LC load network configured to generate an alternating magnetic field during operation of the inductive heating arrangement for inductively heating an aerosol-forming substrate; and
a DC/AC inverter configured to connect to a DC power source having a DC supply voltage and to the LC load network,
wherein the DC/AC inverter comprises:
a voltage sensor configured to measure a DC input voltage drawn from the DC power source;
a transistor;
a transistor driver circuit for the transistor, wherein the transistor driver circuit comprises a tunable oscillator configured to output a switching signal to the transistor; and
a controller configured to receive a voltage signal from the voltage sensor indicative of the DC input voltage,
wherein the controller is configured to determine a switching frequency based on the voltage signal, and
wherein the controller is configured to, in response to the received voltage signal, control the tunable oscillator to tune a switching frequency of the switching signal to the determined switching frequency.

Example Ex2. The inductive heating arrangement according to example Ex1, wherein the DC/AC inverter is configured to operate with different types of DC power sources having different DC supply voltages.

Example Ex3. The inductive heating arrangement according to example Ex2, wherein the different types of DC power sources have different ranges of DC supply voltage during a discharging process.

Example Ex4. The inductive heating arrangement according to one of examples Ex1 to Ex3, wherein the voltage sensor is configured to measure the DC input voltage during operation of the inductive heating arrangement.

Example Ex5. The inductive heating arrangement according to example Ex4, wherein the voltage sensor is configured to measure the DC input voltage in less than 1 second after a start of a heating process.

Example Ex6. The inductive heating arrangement according to one of examples Ex1 to Ex5, wherein the voltage sensor is configured to measure the DC input voltage in a loaded circuit.

Example Ex7. The inductive heating arrangement according to one of examples Ex1 to Ex5, wherein the voltage sensor is configured to measure the DC input voltage in an unloaded circuit.

Example Ex8. The inductive heating arrangement according to one of examples Ex1 to Ex7, wherein the controller is configured to determine the switching frequency based on a conversion table, wherein the conversion table defines a relationship between the voltage signal and the switching frequency.

Example Ex9. The inductive heating arrangement according to example Ex8, wherein the conversion table is incorporated in a firmware of the controller.

Example Ex10. The inductive heating arrangement according to one of examples Ex8 and Ex9, wherein the switching frequency is tunable in a range between 5.4 MHz and 8 MHz.

Example Ex11. The inductive heating arrangement according to one of examples Ex8 and Ex9, wherein the switching frequency is tunable in a range between 6.0 MHz and 7.5 MHz.

Example Ex12. The inductive heating arrangement according to one of examples Ex8 and Ex9, wherein the switching frequency is tunable in a range between 6.4 MHz and 7.2 MHz.

Example Ex13. The inductive heating arrangement according to one of examples Ex8 and Ex9, wherein the switching frequency is tunable in a range between 6.5 MHz to 7.0 MHz.

Example Ex14. The inductive heating arrangement according to one of examples Ex1 and Ex13, wherein the controller is configured to instruct the voltage sensor to measure the DC input voltage.

Example Ex15. The inductive heating arrangement according to one of examples Ex1 and Ex14, wherein the controller is configured to control the tunable oscillator to tune the switching frequency based on only the voltage signal.

Example Ex16. The inductive heating arrangement according to one of examples Ex1 and Ex15, wherein the switching frequency is tuned when the transistor is switched OFF.

Example Ex17. The inductive heating arrangement according to one of examples Ex1 and Ex16, wherein the voltage sensor comprises a voltage divider.

Example Ex18. An inductive heating arrangement according to one of examples Ex1 and Ex17, further comprising the DC power source, wherein the LC load network comprises a capacitor and an inductor, and wherein the inductor is configured to generate an alternating magnetic field during operation of the inductive heating arrangement for inductively heating the aerosol-forming substrate.

Example Ex19. The inductive heating arrangement according to example Ex18, wherein the DC power source comprises at least one nickel cobalt manganese, NCM, battery.

Example Ex20. The inductive heating arrangement according to claim 18, wherein the DC power source comprises at least one lithium iron phosphate, LFP, battery.

Example Ex21. The inductive heating arrangement according to example Ex18, wherein the DC power source comprises at least one of a lithium cobalt oxide and a nickel cobalt aluminum battery.

Example Ex22. The inductive heating arrangement according to one of examples Ex18 to Ex21, wherein the DC supply voltage of the DC power source is in a range of 2.5 Volts to 4.5 Volts.

Example Ex23. The inductive heating arrangement according to one of examples Ex18 to Ex22, wherein a DC supply current of the DC power source is in a range of 1.5 Amperes to 5 Amperes.

Example Ex24. The inductive heating arrangement according to one of examples Ex18 to Ex23, wherein one of:
the inductive heating arrangement comprises an aerosol-generating article comprising the aerosol-generating substrate; and
the inductive heating arrangement is configured to be engaged with an aerosol-generating article comprising the aerosol-generating substrate.

Example Ex25. The inductive heating arrangement according to one of examples Ex1 to Ex24, wherein the controller is configured to determine a switching frequency based on the voltage signal by selecting a predetermined switching frequency corresponding to the voltage signal.

Example Ex26. The inductive heating arrangement according to one of examples Ex1 to Ex25, wherein the DC supply voltage of the DC power source varies in dependence on a state of charge of the DC power source, wherein the state of charge of the DC power source is the current capacity of the battery, or the energy stored in the battery.

Example Ex27. The inductive heating arrangement according to one of examples Ex18 to Ex24, wherein the DC power source is a user-replaceable DC power source.

Example Ex28. The inductive heating arrangement according to one of examples Ex18 to Ex24 and Ex27, wherein the inductive heating arrangement comprises means configured to release the DC power source from the inductive heating arrangement for replacing the DC power source with a different DC power source.

Example Ex29. An aerosol-generating device comprising the inductive heating arrangement according to any one of examples Ex1 to Ex28.

Example Ex30. An inductive heating system comprising:
a first inductive heating device comprising:
   a first DC power source for providing a first DC supply voltage; and
   a first heater module comprising:
      a first DC/AC inverter having a variable switching frequency; and
      a first inductor for providing inductive heating,
wherein the first DC/AC inverter is configured to provide power to the first inductor in accordance with a first switching frequency determined based on the first DC supply voltage; and
a second inductive heating device comprising:
   a second DC power source for providing a second DC supply voltage that is different to
   the first DC supply voltage; and
   a second heater module comprising:
      a second DC/AC inverter having a variable switching frequency; and
      a second inductor for providing inductive heating,
wherein the second DC/AC inverter is configured to provide power to the second inductor in accordance with a second switching frequency determined based on the second DC supply voltage, and
wherein the power provided by the first DC/AC inverter corresponds to the power provided by the second DC/AC inverter. Parts of the first and the second heater module may correspond to parts of the inductive heating arrangement according to one of examples Ex1 to Ex24. According to examples, the first and the second heater module of the system may be the same module or different modules. The first and/or the second DC/AC inverter may be a class-E amplifier.

Example Ex31. An aerosol-generating system according to Ex30, or an aerosol-generating system comprising the aerosol-generating device of Ex29, further comprising an aerosol-generating article for use with the aerosol-generating system.

Example Ex32. A method performed for operating an inductive heating arrangement, the method comprising:
instructing a voltage sensor to measure a DC input voltage drawn from a DC power source;
receiving a voltage signal from the voltage sensor, wherein the voltage signal is indicative of the DC input voltage;
determine a switching frequency based on the voltage signal; and
instruct a tunable oscillator, generating a switching signal for a transistor of the inductive heating arrangement, to tune a switching frequency of the switching signal to the determined switching frequency.

Example Ex33. The method according to example Ex32, wherein the voltage sensor is instructed to measure the DC input voltage during operation of the inductive heating arrangement.

Example Ex34. The method according to one of examples Ex32 and Ex33, wherein the voltage sensor is instructed to measure the DC input voltage in less than 1 second after a start of a heating process.

Example Ex35. The method according to one of examples Ex32 to Ex34, wherein the switching frequency is determined based on a conversion table, wherein the conversion table defines a relationship between the voltage signal and the switching frequency.

Example Ex36. The method according to example Ex35, wherein the conversion table is incorporated in a firmware of a controller.

Example Ex37. The method according to one of examples Ex35 and Ex36, wherein at least one of:
the switching frequency is tunable in a range between 5.4 MHz and 8 MHz.
the switching frequency is tunable in a range between 6.0 MHz and 7.5 MHz.
the switching frequency is tunable in a range between 6.4 MHz and 7.2 MHz.
the switching frequency is tunable in a range between 6.5 MHz to 7.0 MHz.

Example Ex38. The method according to one of examples Ex32 to Ex37, wherein the voltage sensor is instructed to measure the DC input voltage when an aerosol-generating article is engaged with the inductive heating arrangement.

Example Ex39. The method according to one of examples Ex32 to Ex37, wherein the voltage sensor is instructed to measure the DC input voltage when the inductive heating arrangement is not engaged with an aerosol-generating article.

Example Ex40. The method according to one of examples Ex32 to Ex37, wherein the voltage sensor is instructed to measure the DC input voltage when the transistor is switched OFF.

Example Ex41. A computer-readable medium comprising instructions which, when executed by a controller, cause the controller to perform the method according to one of examples Ex32 to Ex40.

Examples will now be further described with reference to the figures in which:

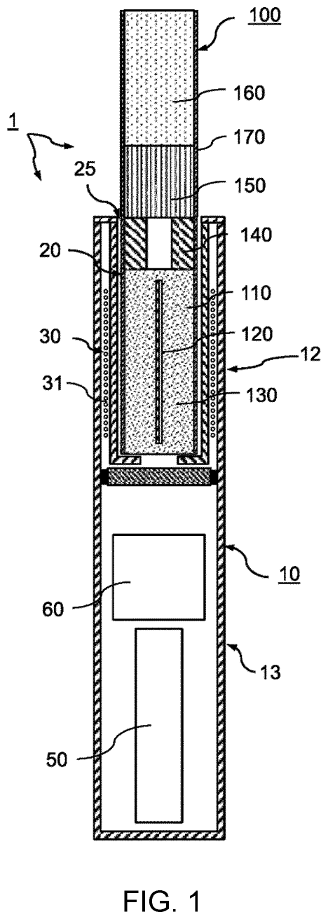

FIG. 1 shows a schematic illustration of an aerosol-generating system according to an aspect;

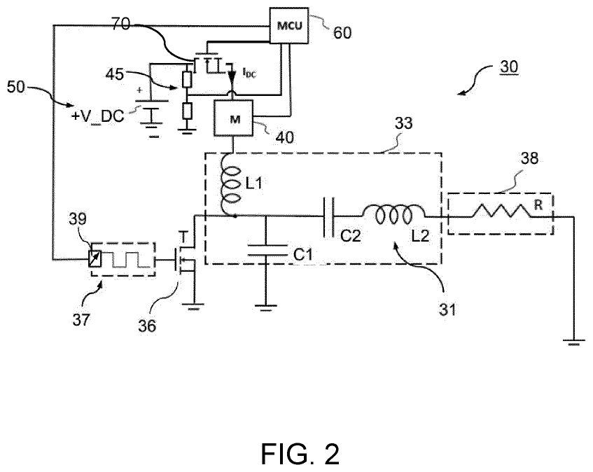

FIG. 2 shows a schematic illustration of an inductive heating arrangement according to an aspect;

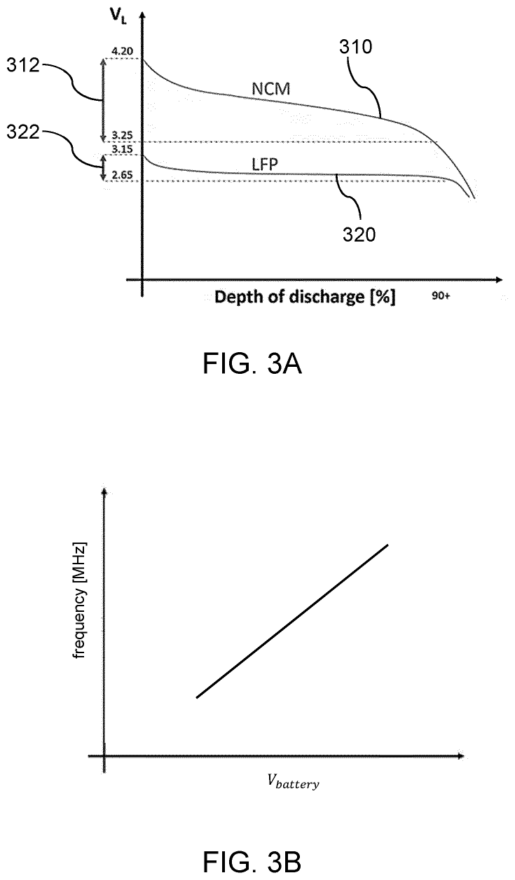

FIG. 3A shows a schematic illustration of a change of voltage over a discharging process for different batteries;

FIG. 3B shows a schematic illustration of a relationship between a switching frequency and a DC input voltage according to an aspect;

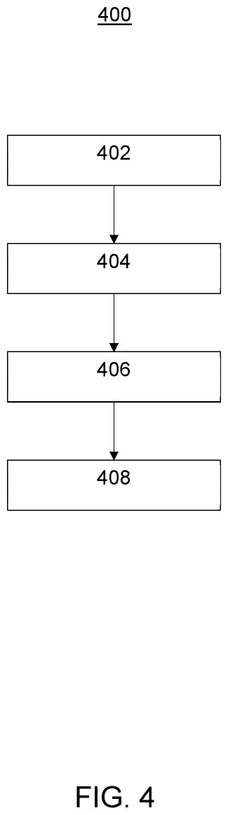

FIG. 4 shows a flow diagram of a method for operating an inductive heating arrangement according to an aspect; and

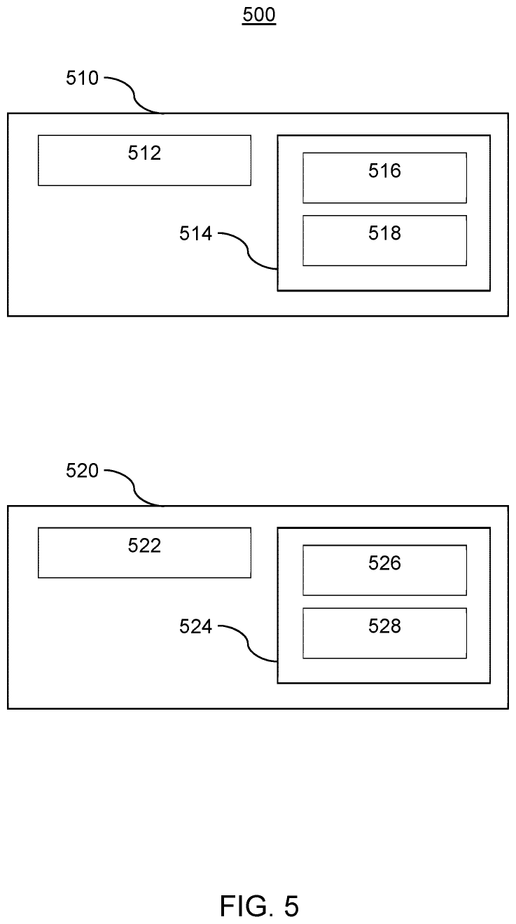

FIG. 5 shows a schematic illustration of an inductive heating system according to an aspect.

FIG. 1 schematically illustrates an example of an aerosol-generating system 1. The system 1 comprises an aerosol-generating device 10 as well as an aerosol-generating article 100 for use with the device, which comprises an aerosol forming substrate to be heated to form an inhalable aerosol.

The aerosol-generating article 100 may be a rod-shaped consumable comprising four elements sequentially arranged in coaxial alignment: an aerosol-forming rod segment 110, a support element 140 having a central air passage, an aerosol-cooling element 150 and a mouthpiece element 160 comprising a filter. The aerosol-forming rod segment 110 may be arranged at a distal end of the article 100 and comprises a strip-shaped susceptor arrangement 120 and the aerosol-forming substrate 130 to be heated. In contrast, the mouthpiece element 160 may be arranged at a proximal end of the article 100 allowing a user to puff thereon. The support element 140 and the aerosol-cooling element 150 are arranged in between. Each of the four elements may be a substantially cylindrical element, all of them having substantially the same diameter. The four elements are circumscribed by an outer wrapper 170 such as to keep the four elements together and to maintain the desired circular cross-sectional shape of the rod-like article 100. The wrapper 170 preferably is made of paper. Further details of the article, in particular of the four elements, are described in WO 2015/176898 A1.

The aerosol-generating device 10 comprises a cylindrical receiving cavity 20 defined within a proximal portion 12 of the device 10 for receiving a least a distal portion of the article 100 therein. The device 10 further comprises an inductive heating arrangement 30 including an inductor 31 for generating an alternating high-frequency magnetic field. The inductor 31 may be a helical coil circumferentially surrounding the cylindrical receiving cavity 20. The coil 31 is arranged such that the susceptor arrangement 120 of the aerosol-generating article 100 is exposed to the alternating magnetic field upon engaging the article 100 with the device 10. Thus, when activating the inductive heating arrangement 30, the susceptor arrangement 120 heats up due to eddy currents and/or hysteresis losses that are induced by the alternating magnetic field within the susceptor arrangement 120, depending on its magnetic and electric material properties. The susceptor arrangement 120 is heated until reaching an operating temperature sufficient to vaporize the aerosol-forming substrate 130 surrounding the susceptor arrangement 120 within the article 100. Within a distal portion 13, the aerosol-generating device 10 further comprises a DC power source 50 and a controller 60 (illustrated in FIG. 1 schematically only) for powering and controlling the heating process.

Even though being part of the aerosol-generating article 100, the susceptor arrangement 120 may be considered as part of the inductive heating arrangement 30. The same holds for the DC power source 50 and the controller 60.

In use of the system 1, when a user takes a puff at the mouthpiece element 160 of the article 100, air is drawn into the cavity 20 at the rim of an article insertion opening 25 of the cavity 20. The air flow further extends towards the distal end of the cavity 20 through a passage which is formed between the inner surface of the cylindrical cavity 20 and the outer surface of the article 100. At the distal end of the cavity 20, the airflow enters the aerosol-generating article 100 through the substrate element 110 and further passes through the support element 140, the aerosol-cooling element 150 and the mouthpiece element 160, where it finally exits the article 100. In the substrate element 110, vaporized material from the aerosol-forming substrate 130 is entrained into the airflow. Subsequently, when passing through the support element 140, the cooling element 150 and the mouthpiece element 160, the airflow including the vaporized material cools down such as to form an inhalable aerosol escaping the article 10 through the mouthpiece element 160.

FIG. 2 shows an example of the inductive heating arrangement 30 according to an aspect, which may be implemented in the aerosol-generating device 10 according to FIG. 1. The inductive heating arrangement 30 comprises a DC/AC inverter, which may be connected to the DC power source 50. The DC/AC inverter may include a class-E power amplifier, that is, a resonant switching power amplifier, which may comprise the following components: a transistor switch 36 comprising a Field Effect Transistor T (FET), for example, a Metal-Oxide-Semiconductor Field Effect Transistor (MOSFET), a transistor switch supply circuit 37 including an oscillator for supplying a switching signal (gatesource voltage) to the transistor switch 36, and an LC load network 33 comprising a shunt capacitor C1 and a series connection of a capacitor C2 and inductor L2. The inductor L2 corresponds to the inductor 31 shown in FIG. 1, which is configured to generate an alternating magnetic field within the cavity 20 during operation of the system 1. In addition, a DC feed choke L1 is provided for supplying the DC supply voltage +V_DC from the DC power source 50. Also shown in FIG. 2 is the ohmic resistance R representing the total equivalent resistance or total resistive load 38, which in operation corresponds to the sum of the ohmic resistance of the inductor 31, marked as L2, and the ohmic resistance of the susceptor arrangement 120 shown in FIG. 1. In case no article is inserted in the cavity 20, the equivalent resistance or resistive load 38 only corresponds to the ohmic resistance of the inductor 31.

In order to account for a possible decrease of the DC supply voltage over time, the inductive heating arrangement 30 comprises a voltage sensor 45 for determining a DC input voltage provided by the DC power source 50. The DC input voltage may be the current voltage applied to the LC load network 33. As shown in FIG. 2, the voltage sensor 45 may comprise a voltage divider. The voltage sensor 45 may be configured to output a voltage signal indicative of the DC input voltage provided by the DC power source during operation of the heating arrangement.

In order to tune the output power of the heating arrangement, in particular to tune the switching frequency of the tunable oscillator 39 to a desired working point on the actual resonance curve of the LC load network, for example, in a desired range around or offset to the resonance frequency of the LC load network 33, the tunable oscillator 39 and the voltage sensor 45 are operatively coupled to the controller 60 in a feedback-loop configuration, as shown in FIG. 2. The controller 60 may be the same as shown in FIG. 1 and configured to receive the voltage signal from the voltage sensor 45 indicative of the DC input voltage. The controller 60 is configured to tune the switching frequency of the switching signal output by the tunable oscillator in response to the received voltage signal in order to tune a current or power drawn from the DC power source to be in the predetermined range. The controller 60 may be further configured to determine an operating switching frequency of the switching signal for which in operation the current drawn from the DC power source 50 is in the predetermined range. Also, the controller 60 may be configured to set up the tunable oscillator 39 to output a switching signal having the determined operating switching frequency.

The inductive heating arrangement 30 according to FIG. 2 may be used in the aerosol-generating device 1 according to FIG. 1. The inductive heating arrangement 30 includes a DC/AC inverter including a resonant switching power amplifier. The resonant switching power amplifier may include a LC load network, a transistor switch 36 and a transistor switch driver circuit 37. The transistor switch driver circuit 37 includes a tunable oscillator 39 configured to output a switching signal to the transistor switch 36 having a tunable switching frequency.

The inductive heating arrangement 30 further includes a voltage sensor 45 for determining the DC input voltage provided by the DC power source 50. The DC input voltage provided by the DC power source 50 may be the DC supply voltage of the DC power source 50. The voltage sensor 45 can be a voltage divider. The voltage can also be measured by directly connecting the battery's positive terminal to the controller via an Analogue to Digital Converter (ADC). Alternatively, the voltage may be measured or obtained by observing current over time and detecting a drop. This yields information on the internal impedance, which relates to the state of charge of the battery and hence the associated voltage.

The voltage sensor 45 is configured to output a voltage signal indicative of the DC input voltage provided by the DC power source during operation of the heating arrangement. The DC input voltage may only be measured 0 seconds to 1 second after the start of the heating process. The DC input voltage could be measured at least one time, two, three, or more times. The DC input voltage may be measured in a loaded-circuit. The loaded-circuit means the aerosol-generating substrate is being inserted into the inductive heating device or engaged with the inductive heating device. For example, the aerosol-generating substrate may be engaged with the inductor L2. Alternatively, the DC input voltage may be calculated or estimated from an unloaded-circuit based on a correlation between the DC input voltage in a loaded- and the DC input voltage in an unloaded-circuit. The value obtained from the unloaded-circuit may be used to estimate the voltage signal at load or in the loaded circuit.

The DC power source 50 may comprise any suitable DC power source configured to provide a DC supply voltage and a DC supply current to the power supply electronics or the inductive heating device. The DC power source 50 may include one or more batteries, such as at least one of lithium iron phosphate, lithium cobalt oxide, nickel cobalt manganese, and nickel cobalt aluminum batteries. The DC power source may be a nickel cobalt manganese battery. The DC power source may be one or more times rechargeable. The DC power source 50 may have a capacity that allows for the storage of enough energy for one or more user experiences of a user using the inductive heating device. The DC supply voltage of the DC power source may be in a range of about 2.5 Volts to about 4.5 Volts. The DC supply current of the DC power source may be in a range of about 1.5 Amperes to about 5 Amperes (corresponding to a DC supply power in the range of about 6.25 Watts and about 22.5 Watts. The power supplied by the inductive heating arrangement 30 may be changed in accordance with a change in the DC supply voltage based on the measured DC input voltage and/or a determined switching frequency corresponding to the DC input voltage.

The inductive heating arrangement 30 further includes a controller 60 which is configured to: (1) order the voltage sensor 45 to measure the DC input voltage; (2) receive the DC input voltage from the voltage sensor 45; (3) determine the switching frequency according to the DC input voltage; and (4) setup the tunable oscillator 39 to output a switching signal having the determined switching frequency.

The controller 60 may be configured to determine the switching frequency based on a conversion table, which may be incorporated in a firmware of the controller 60. The conversion table defines the relationship between the DC input voltage and the switching frequency. The controller determines the switching frequency according to the conversion table. The switching frequency is tunable in a range between 5.4 MHz and 8 MHz, between 6.0 MHz and 7.5 MHz, between 6.4 MHz and 7.2 MHz, or between 6.5 to 7.0 MHz. According to an aspect, the switching frequency is adjusted at the condition of low current or an open circuit.

The inductive heating arrangement 30 further comprises current sensor 40, which is configured to output a current signal indicative of the DC supply current. The current sensor 40 may comprise a sensing resistor and a current shunt amplifier. A measurement result of the current sensor may be used to estimate a temperature of the susceptor.

The inductive heating arrangement 30 may comprise a switch 70 for turning the inductive heating arrangement 30 ON or OFF. The switch 70 may be connected to or placed between the DC power source 50 and the current sensor 40. The controller 60 (MCU) may be configured to control the state of the switch 70. The switch 70 may be any kind of switch. The switch 70 may comprise a Field Effect Transistor (FET), for example, a Metal-Oxide-Semiconductor Field Effect Transistor (MOSFET).

FIG. 3A shows two graphs illustrating a change of the supply voltage over a discharging process for two different batteries. A first graph 310 shows how the supply voltage changes depending on the depth of discharge for NCM batteries. A second graph 320 shows how the supply voltage changes depending on the depth of discharge for LFP batteries. NCM batteries have a higher energy density (170 Wh/kg) compared to LFP batteries (130 Wh/kg). Additionally, as shown in FIG. 3A, NCM batteries have a higher initial voltage (3.8-4.2V) compared to LFP batteries (3.0-3.3V) during a discharging process. Therefore, NCM batteries can provide more energy than LFP batteries. NCM batteries may provide for an increase in energy of 50% compared to LFP batteries.

However, the supply voltage of NCM batteries varies along with the discharging process. As shown in FIG. 3A and indicated by arrow 312, the supply voltage of NCM batteries can vary in a range of about 2.5 Volts to about 4.5 Volts. In contrast, LFP batteries provide for a more constant supply voltage during the discharging process. As indicated by arrow 322, the supply voltage of LFP batteries can vary in a range of about 2.5 Volts to about 3.15 Volts. Since a varying voltage would also affect the power output to the inductor, it is necessary to modulate or adapt the power or supply voltage based on the current supply voltage to provide for a consistent user experience. The inductive heating arrangement according to aspects, such as the inductive heating arrangement 30 according to FIG. 2, solves this problem by measuring the DC input voltage and controlling the transistor 36 based on the measured DC input voltage. The DC input voltage applied to the LC load network may correspond to the DC supply voltage provided by the DC power source. According to an aspect, an aerosol-generating device comprises the inductive heating arrangement according to aspects and may be powered with one or more NCM batteries. Such a device may be used by a user, to consume five or more aerosol-generating articles.

The inductive heating arrangement may include a controller for determining a switching frequency according to the voltage signal. The controller may instruct or configure a tunable oscillator to output a signal having the determined switching frequency to tune the power supplied to the inductor of the inductive heating arrangement. The controller may determine the switching frequency based on a relation between the DC input voltage and a desired switching frequency.

FIG. 3B shows a schematic illustration of a relationship between the switching frequency and the DC supply voltage according to an aspect. For example, the controller may determine a switching frequency based on an equation, such as f=0,2196*V_{battery}+6,0363, where f is the switching frequency and V_{battery} is the measured or estimated DC supply voltage. Alternatively or additionally, the controller may determine the switching frequency based on a look-up table, such as a conversion table.

A conversion table according to aspects may define a relation between switching frequencies and supply voltages or input voltages, as shown in the following table:

| Set Freq [Khz] | Vbat [V] |
|---|---|
| 6.697 | 3.009 |
| 6.719 | 3.109 |
| 6.741 | 3.209 |
| 6.763 | 3.308 |
| 6.785 | 3.409 |
| 6.807 | 3.510 |
| 6.829 | 3.610 |
| 6.851 | 3.710 |
| 6.873 | 3.810 |
| 6.895 | 3.910 |
| 6.917 | 4.010 |
| 6.939 | 4.111 |
| 6.961 | 4.211 |

In a first step, the controller may determine a first switching frequency for a first measured DC input voltage. The controller may instruct or configure the tunable oscillator to output a signal having the determined first switching frequency to tune the power supplied to the inductor of the inductive heating arrangement. In a second step, subsequent to the first step, the controller may determine a second switching frequency for a second measured DC input voltage, where the first measured DC input voltage is greater compared to the second measured DC input voltage, and the first switching frequency is greater compared to the second switching frequency. The controller may instruct or configure the tunable oscillator to output a signal having the determined second switching frequency to tune the power supplied to the inductor of the inductive heating arrangement.

In order to take into account a possible decrease of the DC supply voltage and/or DC input voltage over time, the inductive heating arrangement may further comprise a voltage sensor for determining the DC input voltage of the DC power source. The voltage sensor may comprise a voltage divider. In particular, the voltage sensor may be configured to output a voltage signal indicative of the DC input voltage of the DC power source during or prior to operation of the heating arrangement. Thus, the output power of the inductive heating arrangement device may be determined as a function of the DC supply voltage or the DC input voltage of the DC power source. Using DC/DC converter to adjust the varying voltage from the battery is not effective, since DC/DC converter would cause an energy loss.

FIG. 4 shows a flow diagram of a method 400 for operating an inductive heating arrangement according to an aspect.

In step 402, the method 400 comprises instructing a voltage sensor to measure a DC input voltage provided by a DC power source. The voltage sensor may be instructed to measure the DC input voltage in less than 1 second after a start of a heating process. The voltage sensor may be instructed to measure the DC input voltage when the inductive heating arrangement or a device comprising the inductive heating arrangement is not engaged with an aerosol-generating article.

In step 404, a voltage signal from the voltage sensor is received. The voltage signal is indicative of the DC input voltage.

In step 406, a switching frequency is determined based on the voltage signal. The switching frequency may be determined based on a conversion table, wherein the conversion table defines a relationship between the voltage signal and the switching frequency.

In step 408, a tunable oscillator is configured or instructed to tune a switching frequency of the switching signal to the determined switching frequency, which may tune or modify the DC supply current provided by the DC power source to be in a predetermined range. The tunable oscillator generates a switching signal for a transistor of the inductive heating arrangement.

FIG. 5 shows an example of an inductive heating system 500 according to an aspect. The inductive heating system 500 may comprise a first inductive heating device 510 and a second inductive heating device 520. The first inductive heating device 510 comprises a first DC power source 512 for providing a first DC supply voltage. Additionally, the first inductive heating device 510 comprises a first heater module 514, which comprises a first DC/AC inverter 516 having a variable switching frequency. The first heater module 514 comprises a first inductor 518 for providing inductive heating. The first DC/AC inverter 516 is configured to provide power to the first inductor 518 in accordance with a first switching frequency determined based on the first DC supply voltage.

The second inductive heating device 520 comprises a second DC power source 522 for providing a second DC supply voltage that is different to the first DC supply voltage. Additionally, the second inductive heating device 520 comprises a second heater module 524, which comprises a second DC/AC inverter 526 and a second inductor 528. The second DC/AC inverter 526 is configured to have a variable switching frequency. The second inductor 528 can provide inductive heating. The second DC/AC inverter 526 is configured to provide power to the second inductor 528 in accordance with a second switching frequency determined based on the second DC supply voltage. The power provided by the first DC/AC inverter 516 corresponds to the power provided by the second DC/AC inverter 526. The first and/or the second DC/AC inverter may be a class-E amplifier.

Parts of the first and the second heater module may correspond to parts of the inductive heating arrangement according to FIG. 2. For example, the first inductive heating device 510 may comprise a transistor switch and a transistor switch driver circuit. The transistor switch driver circuit may include a tunable oscillator configured to output a switching signal to the transistor switch. The first inductive heating device 510 may comprise a voltage sensor for determining the DC supply voltage provided by the DC power source 512. Similarly, the second inductive heating device 520 may comprise a transistor switch and a transistor switch driver circuit. The transistor switch driver circuit may include a tunable oscillator configured to output a switching signal to the transistor switch. The second inductive heating device 520 may comprise a voltage sensor for determining the DC supply voltage provided by the DC power source 522.

According to aspects, at least one of the first inductive heating device 510 and the second inductive heating device 520 may be implemented in an aerosol-generating device, such as aerosol-generating device 10 according to FIG. 1.

According to aspects, issues of variable supply voltage output from a DC power source, such as a NCM battery, can be overcome by tuning a switching frequency according to a measured voltage signal. A conversion table, defining a relationship between a supply or input voltage and switching frequency may be incorporated in a firmware of a controller and used to determine a switching frequency for a measured input voltage. The voltage measurement may be performed one or less seconds after a start of a heating process or a start of the inductive heating device. Alternatively, the voltage measurement may be performed one or more seconds after a start of a heating process or a start of the inductive heating device. The voltage measurement may be performed under load, as the open-circuit supply voltage could be misleading. For example, the open-circuit voltage may not correspond to the actual input voltage when the load is applied. In an aspect, the input voltage under load is estimated from the open-circuit voltage.

According to aspects, an induction engine or an inductive heating device, based on a class-E architecture, having a variable switching frequency, is provided. The switching frequency of the induction engine or the inductive heating device may be adjusted based on the voltage signal of the battery for the induction engine or the inductive heating device. With this solution, a power source with varying voltage may be used. This significantly increases the flexibility of the choice of battery. Although this description mainly relates to NCM batteries, different types of batteries or different batteries may be used to power the induction engine or the inductive heating device.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. Within this context, a number A may be considered to include numerical values that are within general standard error for the measurement of the property that the number A modifies. The number A, in some instances as used in the appended claims, may deviate by certain percentages provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An inductive heating arrangement configured to heat an aerosol-forming substrate, the inductive heating arrangement comprising:
an LC load network configured to generate an alternating magnetic field during operation of the inductive heating arrangement to inductively heat the aerosol-forming substrate;
a DC power source; and
a DC/AC inverter configured to connect to the DC power source having a DC supply voltage and to the LC load network,
wherein the DC/AC inverter comprises:
a voltage sensor configured to measure a DC input voltage drawn from the DC power source,
a transistor,
a transistor driver circuit for the transistor, wherein the transistor driver circuit comprises a tunable oscillator configured to output a switching signal to the transistor, and
a controller configured to
receive a voltage signal from the voltage sensor indicative of the DC input voltage,
determine a switching frequency based on the voltage signal,
in response to the received voltage signal, control the tunable oscillator to tune a switching frequency of the switching signal to the determined switching frequency, and
determine the switching frequency based on a conversion table, wherein the conversion table defines a relationship between the voltage signal and the switching frequency.

17. The inductive heating arrangement according to claim 16, wherein the DC/AC inverter is configured to operate with different types of DC power sources having different DC supply voltages.

18. The inductive heating arrangement according to claim 17, wherein the different types of DC power sources have different ranges of DC supply voltage during a discharging process.

19. The inductive heating arrangement according to claim 16, wherein the controller is further configured to determine a switching frequency based on the voltage signal by selecting a predetermined switching frequency corresponding to the voltage signal.

20. The inductive heating arrangement according to claim 16, wherein the voltage sensor is further configured to measure the DC input voltage during operation of the inductive heating arrangement.

21. The inductive heating arrangement according to claim 20, wherein the voltage sensor is further configured to measure the DC input voltage in less than 1 second after a start of a heating process.

22. The inductive heating arrangement according to claim 16,
wherein the voltage sensor is further configured to measure the DC input voltage in a loaded circuit, and
wherein the loaded circuit comprises the aerosol-generating substrate being inserted into or engaged with one of the inductive heating arrangement and a device comprising the inductive heating arrangement.

23. The inductive heating arrangement according to claim 16,
wherein the voltage sensor is further configured to measure the DC input voltage in an unloaded circuit, and
wherein the unloaded circuit comprises no aerosol-generating substrate being inserted into or engaged with the inductive heating arrangement or a device comprising the inductive heating arrangement.

24. The inductive heating arrangement according to claim 16, wherein the conversion table is incorporated in a firmware of the controller.

25. The inductive heating arrangement according to claim 16, wherein at least one of:
the switching frequency is tunable in a range between 5.4 MHz and 8 MHz,
the switching frequency is tunable in a range between 6.0 MHz and 7.5 MHz,
the switching frequency is tunable in a range between 6.4 MHz and 7.2 MHz, and
the switching frequency is tunable in a range between 6.5 MHz to 7.0 MHz.

26. The inductive heating arrangement according to claim 16, wherein at least one of:
the controller is further configured to control the tunable oscillator to tune the switching frequency based on only the voltage signal; and
the DC power source comprises at least one nickel cobalt manganese battery.

27. An aerosol-generating device comprising the inductive heating arrangement according to claim 16.

28. An inductive heating system, comprising:
a first inductive heating device comprising:
a first DC power source configured to provide a first DC supply voltage, and
a first heater module comprising:
a first DC/AC inverter having a variable switching frequency, and
a first inductor configured to provide inductive heating,
wherein the first DC/AC inverter is configured to provide power to the first inductor in accordance with a first switching frequency determined based on the first DC supply voltage; and
a second inductive heating device comprising:
a second DC power source configured to provide a second DC supply voltage that is different from the first DC supply voltage, and
a second heater module comprising:
a second DC/AC inverter having a variable switching frequency, and
a second inductor configured to provide inductive heating,
wherein the second DC/AC inverter is configured to provide power to the second inductor in accordance with a second switching frequency determined based on the second DC supply voltage, and
wherein the power provided by the first DC/AC inverter corresponds to the power provided by the second DC/AC inverter.

29. An aerosol-generating system comprising the inductive heating system according to claim 28 and an aerosol-generating article for the aerosol-generating system.

30. An aerosol-generating system comprising the aerosol-generating device according to claim 27 and an aerosol-generating article for the aerosol-generating system.

31. A method for operating an inductive heating arrangement, the method comprising:
instructing a voltage sensor to measure a DC input voltage drawn from a DC power source;
receiving a voltage signal from the voltage sensor, wherein the voltage signal is indicative of the DC input voltage;
determining a switching frequency based on the voltage signal, wherein the switching frequency is determined based on a conversion table, and wherein the conversion table defines a relationship between the voltage signal and the switching frequency; and
instructing a tunable oscillator to generate a switching signal for a transistor of the inductive heating arrangement and to tune a switching frequency of the switching signal to the determined switching frequency.

32. A nontransitory computer-readable medium having stored thereon instructions that, when executed by a controller, instructs the controller to perform the steps of the method according to claim 16.
